(19) United States
(12) Patent Application Publication
(10) Pub. No.: US 2011/0073236 A1
(43) Pub. Date: Mar. 31, 2011

(54) HIGH STRENGTH BONDING AND COATING MIXTURE

(75) Inventor: Sang In Lee, Sunnyvale, CA (US)

(73) Assignee: FERROTEC (USA) CORPORATION, Bedford, NH (US)

(21) Appl. No.: 12/890,037

(22) Filed: Sep. 24, 2010

Related U.S. Application Data
(60) Provisional application No. 61/277,362, filed on Sep. 25, 2009.

(51) Int. Cl. B32B 37/02; B05D 3/02; C09D 5/00

(52) U.S. Cl. 156/60; 427/228; 106/287.14

(57) ABSTRACT

A mixture includes a silicon compound having a polycarbosilane backbone, and a powder having a plurality of individual powder grains, wherein each of the plurality of powder grains has a diameter substantially between 0.05 micrometers and 50 micrometers.

### CROSS REFERENCE TO RELATED APPLICATIONS

This Patent Application claims the benefit of U.S. Provisional Patent Application No. 61/277,362 filed on Aug. 25, 2009, entitled, “JOINING TWO MEMBERS BY A THERMAL PYROLYSIS OF CARBON-RICH SILICON COMPOUNDS HAVING POLYCARBOSILANE BACKBONE WITH POWDER MIXTURE”, the contents and teachings of which are hereby incorporated by reference in their entirety.

### BACKGROUND OF THE INVENTION

1. Field of the Invention

The present invention relates generally to curable adhesives. In particular, the invention relates to joining work pieces used in semiconductor fabrication equipment.

2. Description of the Prior Art

Batch substrate processing is used in fabricating semiconductor integrated circuits and similar micro structural arrays. In batch processing, many silicon wafers or other types of substrates are placed together on a wafer support fixture in a processing chamber and processed. Most batch processing includes extended exposure to high temperature, for example, in depositing planar layers of oxide or nitride or annealing previously deposited layers or dopants implanted into existing layers. A vertically arranged wafer tower is an example of the support fixture that supports many wafers one above the other in the processing chamber.

Vertical support towers are made of a variety of materials including: quartz, silicon carbide, and silicon. For example, a silicon tower 10, illustrated orthographically in FIG. 1, includes three or more silicon legs 12 joined at their ends to two silicon bases 14. Each leg 12 is cut with slots to form inwardly projecting teeth 16 which slope upwards by a few degrees and have horizontal support surfaces 18 formed near their inner tips 20. A plurality of wafers 22, only one of which is illustrated, are supported on the support surfaces 18 in parallel orientation along the axis of the tower 10.

Vertical support towers, such as the silicon tower 10, require that certain components be joined together. For example, fabricating the silicon tower 10 involves joining the machined legs 12 to the bases 14. As schematically illustrated in FIG. 2, mortise holes 24, which are preferably blind but may be through, are machined into each base 14 with shapes in correspondence with and only slightly larger than ends 26 of the legs 12.

One way of joining components (e.g., those of the vertical support tower 10) includes the use of spin-on glass (SOG). For example, one way to adhere the ends 26 of the legs 12 to walls of the holes 24 of each base 14, involves using SOG, that has been thinned with an alcohol or the like, as a curable adhesive. The SOG is applied to one or both of the members in the area to be joined. The members are assembled and then annealed at 600° C. or above to vitrify the SOG in the seam between the members.

SOG is widely used in the semiconductor industry for forming thin inter-layer dielectric layers so that it is commercially available at relatively low expense and of fairly high purity. SOG is a generic term for chemicals widely used in semiconductor fabrication to form silicate glass layers on integrated circuits. Commercial suppliers include Allied Signal, Filmtronics of Butler, Pa., and Dow Corning. SOG precursors include one or more chemicals containing both silicon and oxygen as well as hydrogen and possibly other constituents. An example of such a precursor is tetraethylorthosilicate (TEOS) or its modifications or an organo-silane such as siloxane or silsesquioxane. When used in an adhesive, it is preferred that the SOG not contain boron or phosphorous, as is sometimes done for integrated circuits. The silicon and oxygen containing chemical is dissolved in an evaporable liquid carrier, such as an alcohol, methyl isobutyl ketone, or a volatile methyl siloxane blend. The SOG precursor acts as a silica bridging agent in that the precursor chemically reacts, particularly at elevated temperature, to form a silica network having the approximate composition of SiO₂.

Another way of joining components (e.g., those of the vertical support tower 10) includes the use of SOG and silicon powder mixture. For example, another way to adhere the ends 26 of the legs 12 to walls of the holes 24 of each base 14, involves using SOG and silicon powder mixture as a curable adhesive. The SOG is applied to one or both of the members in the area to the joined. The members are assembled and then annealed at 400° C. or above to vitrify the SOG in the seam between the members. The silicon powder in the mixture improves the purity of the bond between structural members than if SOG were used alone.

### SUMMARY OF THE INVENTION

Unfortunately there are deficiencies to the above described conventional methods of joining two work pieces together. For example, when using SOG for bonding purposes, the bonded structure and in particular the bonding material may still be excessively contaminated, especially by heavy metal. The very high temperatures experienced in the use or cleaning of the silicon towers, sometimes above 1300° C., may worsen the contamination. One possible source of the heavy metals is the relatively large amount of SOG used to fill the joint between the members to be joined. Siloxane SOG is typically cured at around 400° C. when used in semiconductor fabrication, and the resultant glass is not usually exposed to high-temperature chlorine. However, it is possible that the very high temperature used in curing a SOG adhesive draws out the few but possibly still significant number of heavy metal impurities in the SOG.

Furthermore, the joints joined by SOG adhesive are not as strong as desired. Support towers are subject to substantial thermal stresses during cycling to and from high temperatures, and may be accidentally mechanically shocked over extended usage. It is desirable that the joints not determine the lifetime of the support tower.

Additionally, mixing a silicon powder into the SOG improves the purity of the bond. However joints formed by this silicon powder SOG mixture are still not as strong as may be desirable.

Furthermore, yet another deficiency of the above described conventional joining methods is that they are not selectively conductive or non-conductive.

In contrast to the above described conventional methods of joining two work pieces together, an improved method for bonding two work pieces together includes using a mixed silicon compound (precursors) having a polycarbosilane backbone with bonding powder. When heated, silicon compounds having polycarbosilane backbone decompose into fragments. These fragments may be gaseous atoms or radicals of silicon and/or carbon. Recombination of gaseous silicon and carbon followed by condensation gives SiC in solid state. The excess carbon allows carbon-impregnation processes on the work pieces and powders imbedded within SiC bridging matrix, resulting in joining either conductive joining or non-conductive joining of workpieces with a covalent bonding force. Conductivity of the joining depends on the mixing powders. For example, conducting powders such as metal, and doped Si provide for a conducting joining.

For example, one embodiment is directed to a mixture having a silicon compound having a polycarbosilane backbone, and a powder having a plurality of individual powder grains, wherein each of the plurality of powder grains has a diameter substantially between 0.05 micrometers and 50 micrometers.

### BRIEF DESCRIPTION OF THE DRAWINGS

FIG. 1 is an orthographic view of a silicon wafer tower.

FIG. 2 is an orthographic view of two members of the tower of FIG. 1 and how they are joined.

FIG. 3 is a diagram of a mixture.

FIG. 4 is a chemical formula of an embodiment of a component of the mixture of FIG. 3.

FIG. 5 is a chemical formula of another embodiment of the component of the mixture of FIG. 3.

FIG. 6 is a diagram of a pre-curing assembly

FIG. 7 is a graph showing the heating and cooling cycles applied to the pre-curing assembly of FIG. 6.

FIG. 8 is a phase diagram of an example mixture during pyrolysis.

FIG. 9 is a diagram of a post-curing assembly.

FIG. 10 is a table comparing the bond strength and conductivity properties of various combinations of work pieces and powders.

FIG. 11 is a flowchart showing a method of joining two work pieces together.

FIG. 12a is a diagram showing an improved way of bonding a coating to a workpiece.

FIG. 12b is a diagram showing an improved way of bonding a coating to a workpiece.

FIG. 12c is a diagram showing an improved way of bonding a coating to a workpiece.

FIG. 12d is a diagram showing an improved way of bonding a coating to a workpiece.

### DETAILED DESCRIPTION OF THE PREFERRED EMBODIMENT

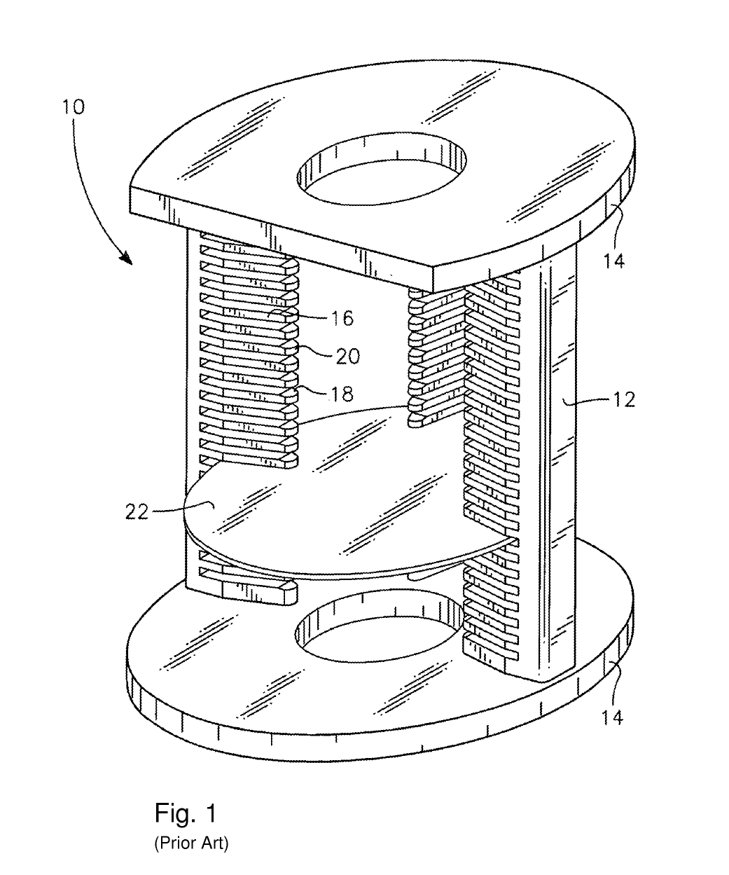

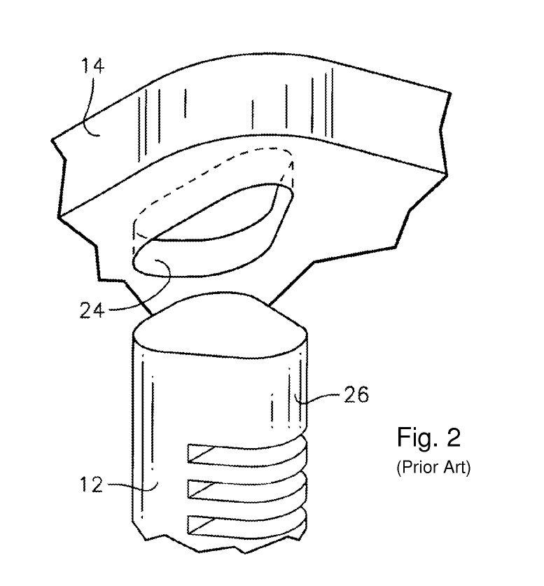

The preferred embodiment(s) of the present invention is illustrated in FIGS. 1-12.

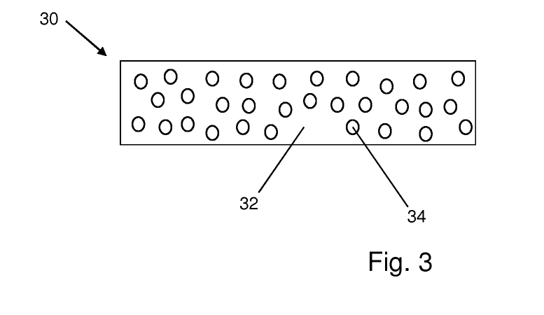

FIG. 3 shows a mixture 30 of silicon compounds (precursers) 32 having a polycarbosilane backbone and a powder mixture 34.

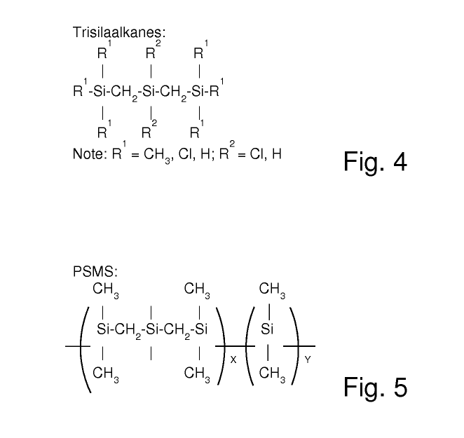

Examples of the silicon compounds 32 include polysilamethylenosilane (PSMS), Trisilaalkanes, Dimethyltrisilaheptanes, Dimethyldichlorosilane, cyclic[—CH₂SiCl₂—]₃, and mixtures of these precursors. The formula for Trisilaakanes is shown in FIG. 4 and the formula for PSMS is shown in FIG. 5.

The powder mixture 34 may be made of a number of different materials depending on the work piece that the mixture 30 is to be applied to and the level of conductivity that is desired. For example, in some arrangements, the powder mixture 34 is made of metals capable of forming carbide compounds (e.g., refractory metals including Ti, Ta, Mo, W, etc.). Additionally, in other arrangements, the powder mixture 34 is made of semiconductors (e.g., Si, doped-Si, SiGe, doped-SiGe, GaAs, SiC, etc.). In other arrangements, the powder mixture 34 is made of carbides (e.g, SiC, SiGeC, GeC, TiC, TaC, etc.). In yet other arrangements, the powder mixture 34 is made of carbon or graphite.

Individual grains of the powder mixture 34 are sized with diameters between 0.05 μm˜50 μm. Additionally, the powder mixture 34 takes up less than 70% of the volume of the mixture 30.

In use, for example, the mixture 30 is used to bond two work pieces together. Work pieces may be made of various materials including ceramic, refractory metals, semiconductors (e.g., Si, SiGe, SiC, doped Si, doped-SiGe, etc.), and graphite.

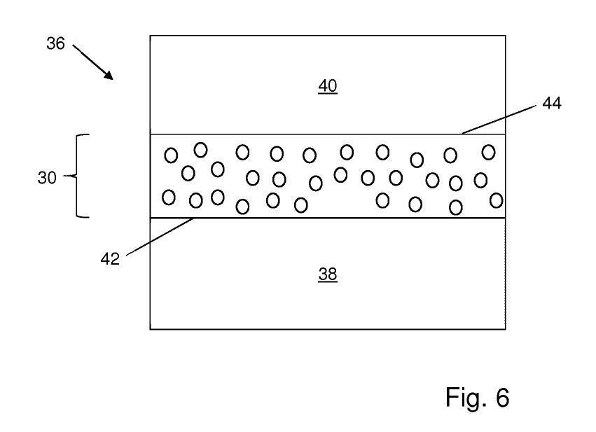

FIG. 6 shows a pre-curing assembly 36 having a first work piece 38 and a second work piece 40 prior to curing. The mixture 30 is applied to join together the first work piece 38 and the second work piece 40 at a first surface 42 and a second surface 44 respectively. In some arrangements, the first surface 42 and the second surface 44 are subject to surface cleaning prior to the application of the mixture 30. Surface cleaning is done to remove any potential impurities that could potentially interfere with creating a strong bond during the curing process.

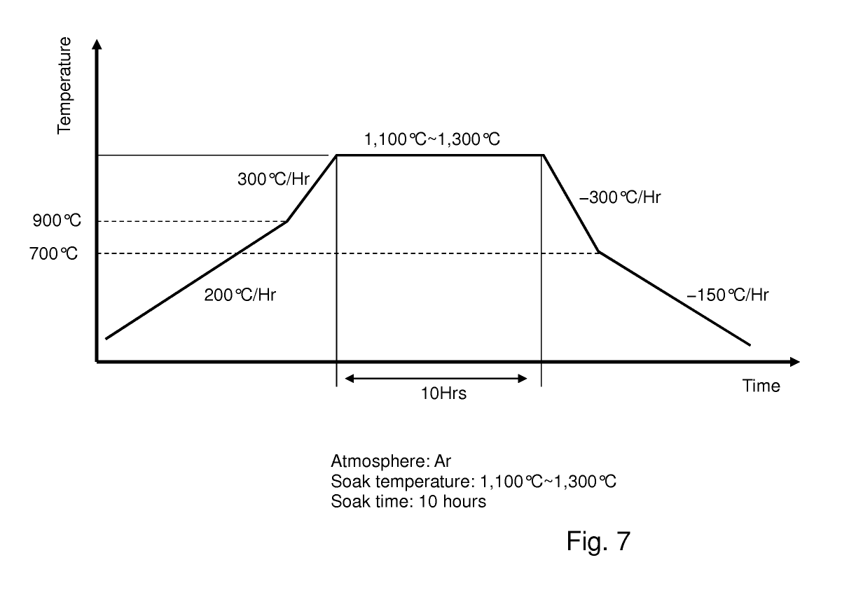

To form the bond between the first work piece 38 and the second work piece 40, the pre-curing assembly 36 is subjected to heating and cooling cycles as seen in FIG. 7. A strong bond is formed by curing the pre-curing assembly 36 at a temperatures approximately between 1,100° C. and 1,300° C. in an inert or reduction environment for an extended period of time. The use of an inert or reduction environment prevents unwanted oxidation reactions from occurring that could potentially weaken the overall strength of the bond. For example, the pre-curing assembly 36 is immersed in an atmosphere of substantially pure argon (i.e., an inert environment). The pre-curing assembly 36 is then: (i) heated at a rate of 200° C./Hr until a temperature of 900° C. is reached; (ii) heated at a rate of 300° C./Hr until a temperature of approximately between 1,100° C. and 1,300° C. is reached; maintained at the temperature of approximately between 1,100° C. and 1,300° C. for a duration of approximately ten hours; (iii) cooled at a rate of 300° C./Hr until a temperature of 700° C. is reached; and (iv) cooled at rate of 150° C./Hr until room temperature is reached. By the conclusion of the above described heating and cooling cycles, the pre-curing assembly 36 becomes a post-curing assembly 46.

During heating, the mixture 30 undergoes pyrolysis (or sintering). The silicon compounds 32 having the polycarbosilane backbone decompose into fragments. These fragments may be gaseous atoms or radicals of silicon and/or carbon. Recombination of gaseous silicon and carbon followed by condensation produces SiC in solid state. Excess carbon allows carbon-impregnation processes to occur on the work pieces 38, 40 and powders 34 imbedded within the newly formed SiC bridging matrix. Thus strong covalent bonds are formed between the first work piece 38 and the second work piece 40.

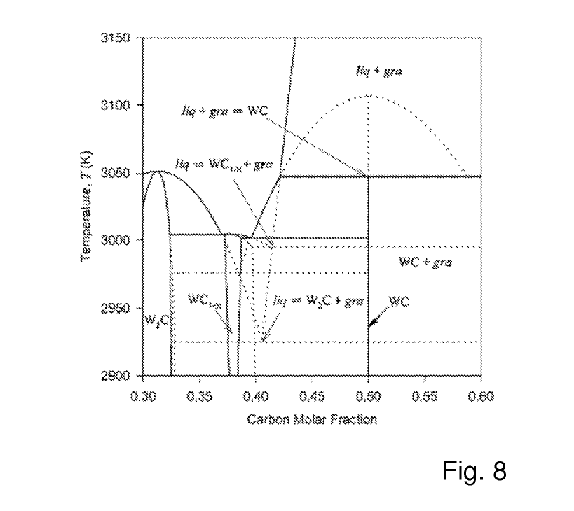

FIG. 8 shows a phase chart for an example pyrolysis reaction. In this example, the silicon compound 32 having polycarbosilane backbone is Dimethyldichlorosilane, and the powder 34 is tungsten powder. When the mixture 30 is heated at temperatures approximately between 1,100° C. and 1,300° C. in an argon atmosphere for ten hours, the products: WC(powder)+W(Si)C(powder)+SiC+by-products(volatile gases) are produced.

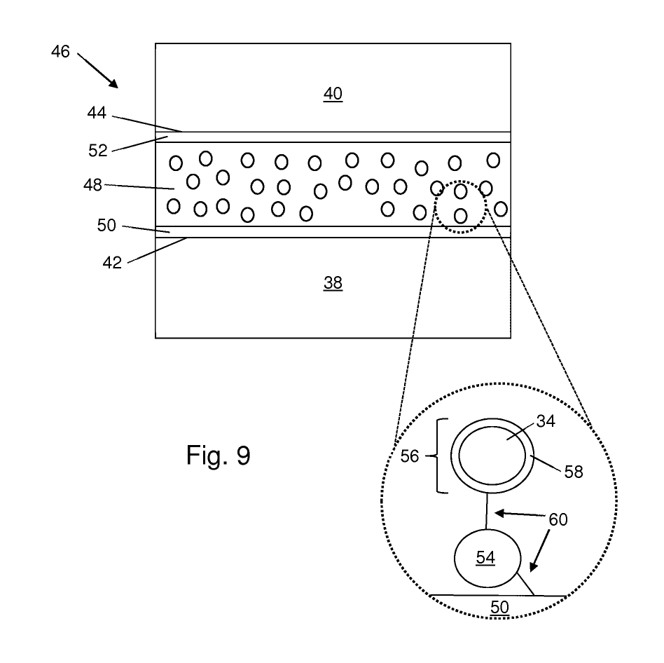

FIG. 9 shows the post-curing assembly 46 having the first work piece 38 and the second work piece 40 subsequent to curing. The post-curing assembly 46 also includes a SiC bridging matrix 48, a first carbide layer 50, a second carbide layer 52, carbonized particles 54, and carbide-surface-layer particles 56.

The SiC bridging matrix 48 (i.e., Nano-sized “Carbon-rich (0<C≦15 at. %) SiC”) is pyrolyzed from the silicon compounds 32 having the polycarbosilane backbone by high temperature pyrolysis (or sintering) process at 1,100° C.˜1,300° C. for several hours in inert atmosphere (e.g., Ar, N₂).

After the thermal pyrolysis process, the first carbide layer 50 forms between the first surface 42 of the first work piece 38 and the SiC bridging matrix 48 by a diffusion process between first work piece 38 and gaseous atoms or radicals of silicon and/or carbon, and/or carbon-impregnation process caused by a precursor decomposition.

Similarly, after the thermal pyrolysis process, the second carbide layer 52 forms between the second surface 44 of the second work piece 40 and the SiC bridging matrix 48 by a diffusion process between second work piece 40 and gaseous atoms or radicals of silicon and/or carbon, and/or carbon-impregnation process caused by a precursor decomposition.

After the thermal pyrolysis process, a powder carbide layer 58 (e.g., SiC, SiGeC, Ti(Si)C, Ta(Si)C, Mo(Si)C, W(Si)C, etc.) forms on bigger powder particles 34 (i.e., powder particles 34 with diameters greater than 1 μm) to create the carbide-surface-layer particles 56. The powder carbide layer 58 is formed by the carbon-impregnation and/or diffusion process. Smaller powder particles 34 (i.e., powder particles 34 with diameters less than 1 μm) are fully transformed into the carbonized particles 54. The carbonized particles 54 are also formed by the carbon-impregnation and/or diffusion process.

The strong bond between the first work piece 38 and the second work piece 40 is due to covalent bonding 58. In particular, the covalent bonding 58 among the carbide layers 50, 52, the carbonized particles 54, and the carbide-surface-layer particles 56.

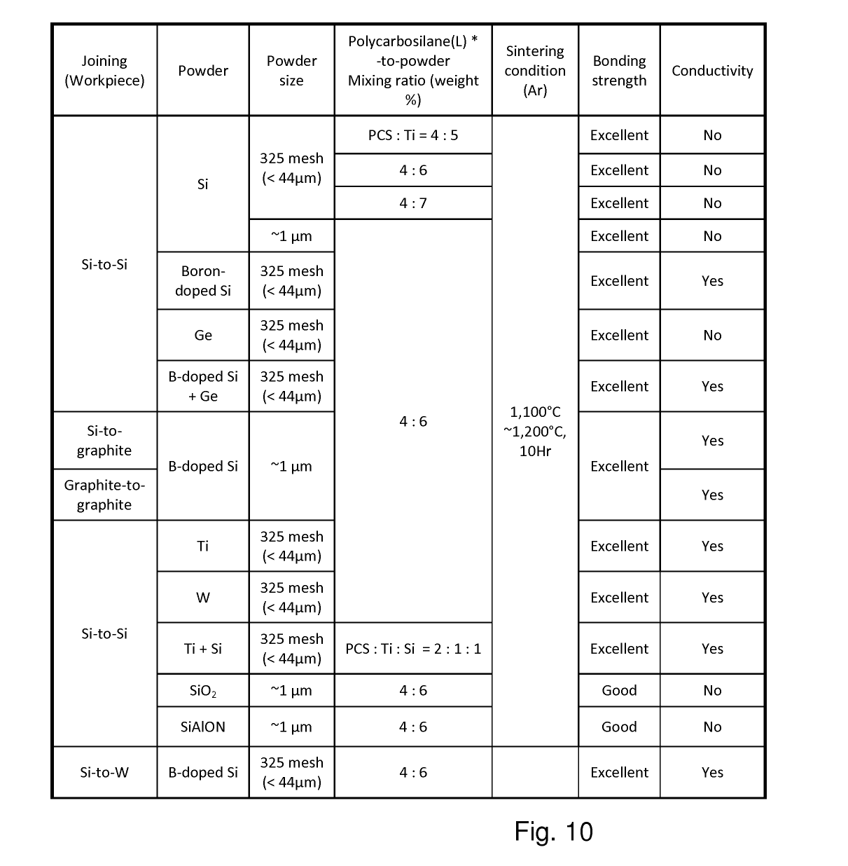

FIG. 10 is a chart showing the bonding qualities and conductivity for various combinations of work pieces 38, 40, powder mixtures 34 when using a polycarbosilane as the silicon compounds 32. In particular the polycarbosilane used is (i) Dimethyldichlorosilane+solvent(10% toluene); or (ii) (Mixture of Dimethyldichlorosilane+cyclic[—CH₂SiCl₂—]₃)+10% toluene.

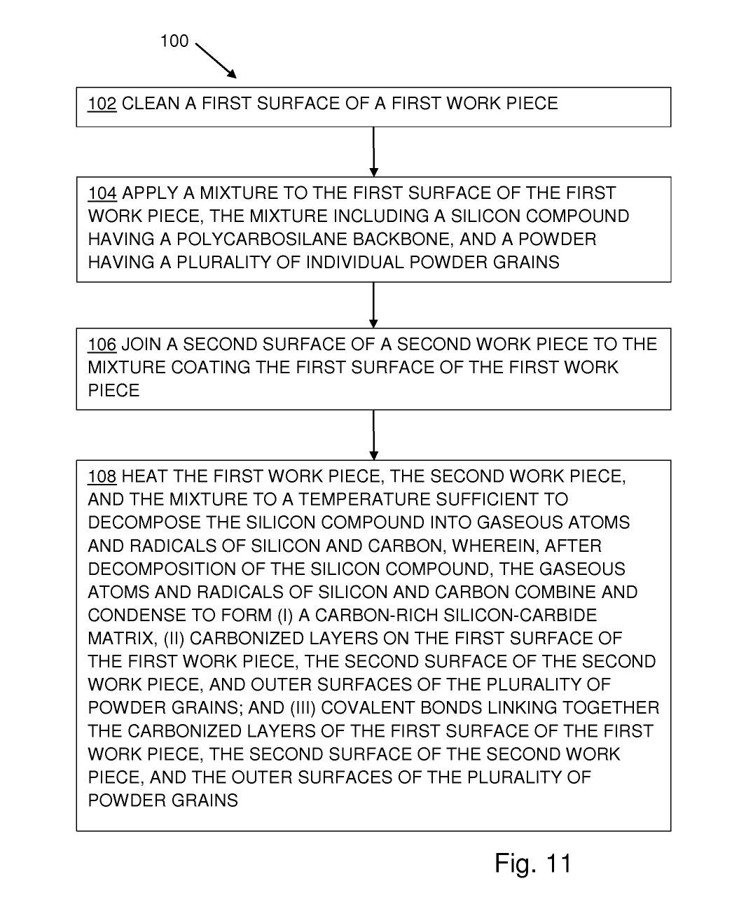

FIG. 11 is a flow chart showing a method 100 for adhering two work pieces 38, 40 together.

Step 102 is to clean the surface 42 of the first work piece 38. This cleaning may be done physically and/or chemically to remove surface 42 impurities and promote a strong bonding.

Step 104 is to apply the mixture 30 to the surface 42 of the first work piece 38, the mixture 30 including a silicon compound 32 having a polycarbosilane backbone, and a powder 34 having a plurality of individual powder grains.

Step 106 is to join the surface 44 of the second work piece 40 to the mixture 30 coating the surface 42 of the first work piece 38.

Step 108 is to heat the first work piece 38, the second work piece 40, and the mixture 30 to a temperature sufficient to decompose the silicon compound 32 into gaseous atoms and radicals of silicon and carbon, wherein, after decomposition of the silicon compound, the gaseous atoms and radicals of silicon and carbon combine and condense to form (i) a carbon-rich silicon-carbide matrix 48, (ii) carbonized layers 50, 52, 58 on the first surface 42 of the first work piece 38, the second surface 44 of the second work piece 40, and outer surfaces of the plurality of powder grains 34; and (iii) covalent bonds 60 linking together the carbonized layers 50, 52, 58 of the first surface 42 of the first work piece 38, the second surface 44 of the second work piece 40, and the outer surfaces of the plurality of powder grains 38.

There are other uses for the mixture 30 other than joining together work pieces 38, 40. In some embodiments, the mixture 30 is used as a protective coating for objects subject to harsh conditions such as those found in semiconductor manufacturing processes. For example, in semiconductor manufacturing processes, polysilicon films are required for making conductors such as word-lines, bit-lines, and resistors. Low-pressure chemical vapor deposition (LPCVD) equipment is used to create these polysilicon films. Additionally, LPCVD equipment uses a quartz bell jar as an outer tube to control atmosphere. During operation of the LPCVD equipment, polysilicon is deposited on an inner surface of the quartz bell jar. As the thickness of the polysilicon film increases, the strain of the accumulated film ultimately exceeds its yield strength (due of the differences in thermal expansion coeffcients between the polysilicon and the quartz), and the film peels off and generates particulates.

By applying the mixture 30 the surface of a workpiece 38 (e.g., interior surface of the quartz bell jar) sintering at high temperature in the same way as described above with respect to bonding workpieces 38, 40, the film peel-off problem is reduced. The coatings are “nano-structured SiC-based coatings” which covered the workpiece, and the bonding strength of the coatings is very high because the radicals of silicon and carbon from the precursor reacts with the mixed powders and the surface of the work piece during heat treatment. This chemical reaction produces covalent bonding between powders, bridging matrix, and the surface of the workpieces. So, the coating will allow work pieces such as the quartz bell jar to be cleaned less often because it accommodates the film stress.

To increase the adhesion of the coating 30, certain surface treatments provide recesses with tangential angles smaller than 90 degrees to allow anchoring of the coating into the work piece 38.

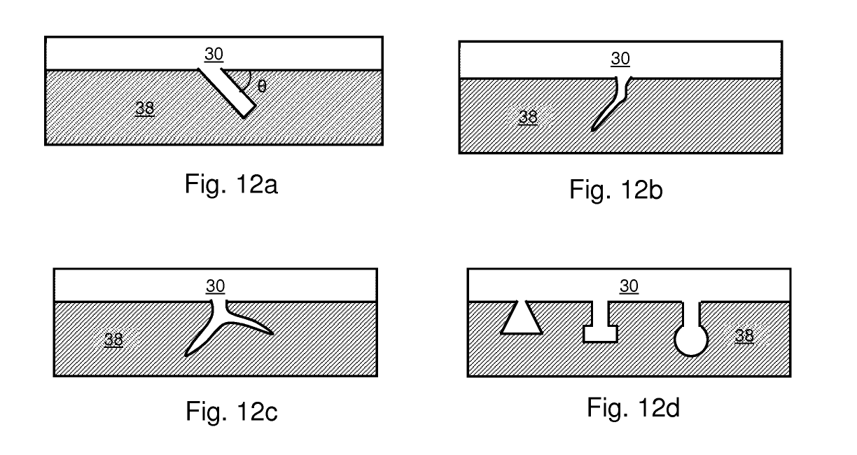

As seen in FIG. 12a one way of producing recesses with tangential angles smaller than 90 degrees is by laser drilling at an angle θ (i.e. less than 90 degrees) from the surface of the work piece 38. The coating 30 upon curing, in addition to being covalently bonded to the work piece 38, is mechanically hooked into the work piece 38.

As seen in FIG. 12b another way of producing recesses with tangential angles smaller than 90 degrees is by SiC bead blasting an angle less than 90 degrees from the surface of the work piece 38. The coating 30 upon curing, in addition to being covalently bonded to the work piece 38, is mechanically hooked into the work piece 38.

As seen in FIG. 12c another way of producing recesses with tangential angles smaller than 90 degrees is by SiC bead in multiple directions from the surface of the work piece 38 to produce a branching structure. The coating 30 upon curing, in addition to being covalently bonded to the work piece 38, is mechanically hooked into the work piece 38.

As seen in FIG. 12d yet another way of producing recesses with tangential angles smaller than 90 degrees is by chemically treating an angle less than 90 degrees from the surface of the work piece 38. For example, first grow or deposit SiO₂ as an etch mask (10 nm˜100 nm). Then create a pattern by lithographic process or laser drilling. Then dip the work piece 38 in KOH to resolve silicon (etch selectivity: Si:SiO2=100˜500:1). Finally, remove SiO₂ by dipping in HF. The coating 30 upon curing, in addition to being covalently bonded to the work piece 38, is mechanically hooked into the work piece 38.

When the mixture 30 is used as a coating, conductive properties may be preselected similar to as was done when using the mixture for bonding. For example, a non-conductive work piece may be changed into a conductive work piece by selecting powders 34 that are metallic. This produces, for example, a conductive coating on insulating ceramics to resolve “charging” in plasma systems or an ion implater.

Another application is a passivation of the work piece. The base material is SiC which is a chemically inert material, does not dissolved in HF and KOH. So, deposited silicon film on the coating can be removed by dipping in KOH solution, and can be recycled the work piece.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A mixture comprising:
a silicon compound having a polycarbosilane backbone; and
a powder having a plurality of individual powder grains, wherein each of the plurality of powder grains has a diameter substantially between 0.05 micrometers and 50 micrometers.

2. The mixture of claim 1, wherein the silicon compound having the polycarbosilane backbone is selected from the group of polysilamethylenosilane, Trisilaalkanes, Dimethyltrisilaheptanes, Dimethyldichlorosilane, and cyclic[—CH₂SiCl₂—]₃.

3. The mixture of claim 1, wherein the powder is a metal capable of forming carbide compounds and is selected from the group of titanium, tantalum, molybdenum, and tungsten.

4. The mixture of claim 1, wherein the powder is a semiconductor and is selected from the group of silicon, doped-silicon, silicon-germanium, doped-silicon-germanium, and gallium arsenide.

5. The mixture of claim 1, wherein the powder is a carbide and is selected from the group of silicon carbide, silicon-germanium carbide, germanium carbide, titanium carbide, and tantalum carbide.

6. The mixture of claim 1, wherein the powder is graphite.

7. A method for adhering a first work piece to a second work piece, the first work piece defining a first surface, the second work piece defining a second surface, the method comprising:
applying a mixture between the first work piece at the first surface and the second work piece at the second surface;
wherein the mixture includes:
a silicon compound having a polycarbosilane backbone, and
a powder having a plurality of individual powder grains, wherein each of the plurality of powder grains has a diameter substantially between 0.05 micrometers and 50 micrometers; and
heating the first work piece, the second work piece, and the mixture to a temperature sufficient to decompose the silicon compound into gaseous atoms and radicals of silicon and carbon, wherein the heating takes place in either one of an inert environment and a reduction environment;
wherein, after decomposition of the silicon compound, the gaseous atoms and radicals of silicon and carbon combine and condense to form (i) a carbon-rich silicon-carbide matrix, (ii) carbonized layers on the first surface of the first work piece, the second surface of the second work piece, and outer surfaces of the plurality of powder grains; and (iii) covalent bonds linking together the carbonized layers of the first surface of the first work piece, the second surface of the second work piece, and the outer surfaces of the plurality of powder grains.

8. The method of claim 7, wherein the silicon compound having the polycarbosilane backbone is selected from the group of polysilamethylenosilane, Trisilaalkanes, Dimethyltrisilaheptanes, Dimethyldichlorosilane, and cyclic [—CH₂SiCl₂—]₃.

9. The method of claim 7, wherein the powder is a metal capable of forming carbide compounds and is selected from the group of titanium, tantalum, molybdenum, and tungsten.

10. The method of claim 7, wherein the powder is a semiconductor and is selected from the group of silicon, doped-silicon, silicon-germanium, doped-silicon-germanium, and gallium arsenide.

11. The method of claim 7, wherein the powder is a carbide and is selected from the group of silicon carbide, silicon-germanium carbide, germanium carbide, titanium carbide, and tantalum carbide.

12. The method of claim 7, wherein the powder is graphite.

13. A method for providing a protective coating to a work piece, the work piece defining a surface, the method comprising:
applying a mixture to the surface the work piece;
wherein the mixture includes:
a silicon compound having a polycarbosilane backbone, and
a powder having a plurality of individual powder grains, wherein each of the plurality of powder grains has a diameter substantially between 0.05 micrometers and 50 micrometers; and
heating the work piece, and the mixture to a temperature sufficient to decompose the silicon compound into gaseous atoms and radicals of silicon and carbon, wherein the heating takes place in either one of an inert environment and a reduction environment;
wherein, after decomposition of the silicon compound, the gaseous atoms and radicals of silicon and carbon combine and condense to form (i) a carbon-rich silicon-carbide matrix, (ii) carbonized layers on the surface of the work piece and outer surfaces of the plurality of powder grains; and (iii) covalent bonds linking together the carbonized layers of the surface of the work piece and the outer surfaces of the plurality of powder grains.

14. The method of claim 13, further comprising:
prior to applying the mixture to the surface the work piece, providing recesses on the surface of the work piece, the recesses having tangential angles smaller than 90 degrees constructed and arranged to allow the carbon-rich silicon-carbide matrix to anchor into the work piece.

15. The method of claim 14, wherein providing the recesses on the surface of the work piece is done by one of laser drilling, silicon bead blasting, and lithographic processing.

16. The method of claim 13, wherein the silicon compound having the polycarbosilane backbone is selected from the group of polysilamethylenosilane, Trisilaalkanes, Dimethyltrisilaheptanes, Dimethyldichlorosilane, and cyclic[—CH₂SiCl₂—]₃.

17. The method of claim 13, wherein the powder is a metal capable of forming carbide compounds and is selected from the group of titanium, tantalum, molybdenum, and tungsten.

18. The method of claim 13, wherein the powder is a semiconductor and is selected from the group of silicon, doped-silicon, silicon-germanium, doped-silicon-germanium, and gallium arsenide.

19. The method of claim 13, wherein the powder is a carbide and is selected from the group of silicon carbide, silicon-germanium carbide, germanium carbide, titanium carbide, and tantalum carbide.

20. The method of claim 13, wherein the powder is graphite.
